(19) United States
(12) Patent Application Publication
(10) Pub. No.: US 2023/0102008 A1
(43) Pub. Date: Mar. 30, 2023

(54) Nanowire Coating For Heating And Insulation

(71) Applicant: Budderfly, Inc., Shelton, CT (US)

(72) Inventors: Albert Subbloie, Orange, CT (US); Kenneth Buda, Scarsdale, NY (US)

(21) Appl. No.: 17/987,384

(22) Filed: Nov. 15, 2022

Related U.S. Application Data
(63) Continuation-in-part of application No. 15/820,031, filed on Nov. 21, 2017, now abandoned.
(60) Provisional application No. 62/424,765, filed on Nov. 21, 2016.

(51) Int. Cl. C08K 3/08; C09D 121/02; C09D 133/08

(52) U.S. Cl. CPC C08K 3/08; C09D 121/02; C09D 133/08; C08K 2003/0806; C08K 2201/001

(57) ABSTRACT

A nanowire heating and insulating element that includes a first layer having overlapping nanowires dispersed therein and a second layer that is two conductive portions spaced apart on either side of the first layer. Electrical potential is applied to the two conductive portions such that electricity flows through the nanowires of the first layer to heat the heating element. In addition, the heating element may be applied to existing surfaces of a room having a multiple sensor pack therein which is in wireless communication with multiple devices, or Adaptors. One or more of the adaptors supply electrical potential for the heating element and is in wireless communication with a controller which is configured to monitor usage of the Adaptors and control the Adaptors as needed to respond to usage events or environmental conditions based at least in part on readings from the sensor pack.

### FIELD OF THE INVENTION

The following relates to an easy to apply nanowire based heating element that in some embodiments is applied to a room via paint or a film, in some embodiments, a sensor pack and underlying software enables granular control of the nanowire heating elements on a space by space basis using a sophisticated software program and arrangement of hardware devices (IoT) where the devices use the sensor pack and/or include control and measurement features such that energy usage can be controlled on a granular level in response to demand based events.

### BACKGROUND OF THE INVENTION

Traditional forms of temperature control for commercial and residential buildings include several known methods including, mechanical processes (e.g., heat transfer via hot water radiation, heat pump applications and forced air systems with heating coils among other systems) and electrical processes (e.g., electrical resistance heating such as radiant heaters).

One of the most difficult issues with upgrading or changing any heating system is the capital expense and labor involved in retrofitting a space. All of the above methods require the installation of systems to control the temperature in a space. For example, systems that utilize electrical resistance heating, while the installation of the system is typically less expensive to install than a hot water based heating system, the operating cost for running electrical heat in a space can be exorbitant. Additionally, there still is a need to install the electrical wiring to provide the electrical power needed to be converted to heat by the electrical resistance heaters that must be located in the space to be heated. This can be challenging in an existing structure and oft times involves intensive labor costs as electrical wiring is installed in the walls of a structure after the fact.

For hot water based systems, while these are generally less costly to run than electrical heating, the installation costs are typically much higher and the impact on an existing structure can be substantial. It is not uncommon to have to open up the walls of existing structures in order to install the necessary piping for such a system as well as find the space in the areas to be heated for the radiation heaters. Likewise, the infrastructure needed for such a system often requires a dedicated space for the equipment to generate the hot water and for the circulation pumps and all the associated equipment.

For forced air systems, these can also use a hot water based system for supplying hot water to coils located in an air duct. This type of system requires a relatively large amount of space for ductwork in the ceiling/floor, it needs all the hot water generating equipment as used in a radiation type system described above, and it needs the air handling systems for generating the flow of air through the ductwork. In short, to install such a system typically requires the ceiling of a commercial space to be completely opened up to install the forced air system.

Further, water/steam based heating systems typically require separate loops or controls to be installed in each space/radiator to effectively control heating in a particular space. In addition, many water/steam heating systems directly consume fossil fuels for energy supply (e.g., oil and natural gas furnaces).

Accordingly, a system is needed that addresses the limitations of the above-described systems.

As the Internet of Things (IoT) becomes more prevalent, devices using IoT are becoming available for both home and commercial settings. For example, thermostats such as the NEST® thermostat are designed to include a thermostat controller, temperature sensor and Wi-Fi module all in a single housing that can replace an existing thermostat that is not network enabled. While there may be some operating benefits in adding a controller to an existing heating system, the control and scheduling functions are really limited to the heating and cooling system.

Other control systems for the IoT include Wi-Fi enabled switches such as, the WEMO® by Belkin. This switch is adapted to connect to existing wiring and includes a Wi-Fi module that connects to the Internet. In both instances, the user is able to control the lights in a space with one application and the heating/cooling system via another application. However, in a room with both a Nest thermostat and a WEMO switch, the sensors in the Nest thermostat do not communicate with the WEMO switch. Further, each of the sensors is purpose built for a single device, meaning the Nest sensor can only work to control the single thermostat to which it is connected. So while these sensors are considered “smart” sensors, they are not smart enough to communicate with each other. Instead, they are limited communicating with and controlling only a specific system they are provided for based on the configuration of the underlying existing building system.

In a commercial setting, temperature control is typically a significant expense and it is difficult to determine where usage is occurring and how that usage can be contained.

In some instances, energy consumption could be reduced and/or minimized when a room is not occupied or heating can be adjusted to fit a particular user's comfort level. However, existing temperature control systems do not provide for the ability to custom control spaces in this manner.

### SUMMARY OF THE INVENTION

It is therefore an object of the present invention to provide a heating system that can be installed using existing electrical wiring to provide more granular temperature control to various building spaces.

It is another object to provide a temperature control system that can monitor and respond to conditions and usage at an increased granular level and in a more efficient manner than known heating systems.

It is further desired to provide a system that is adapted to automatically respond to usage events and/or environmental conditions to limit the expense of controlling the temperature in a space.

It is further desired to provide a system that is adapted to be connected to multiple networked energy consuming devices on a space by space basis to more effectively control usage.

It is still further desired to provide a heating system that can be applied to a wall in the form of a via paint or a film to provide heating for the space.

In view of the above, a system is provided for controlling the temperature of a space using a technology that does not locally burn fossil fuel, is highly energy efficient, does not use a fluid as a transfer agent, is easily installed in a new or existing building and requires little maintenance. The system provides the added benefit of providing a significant additional level of insulation to a space.

The above listed objects are achieved in one configuration by providing a nanowire heating element that includes a first layer having overlapping nanowires dispersed therein and a second layer that is two conductive portions spaced apart on either side of the first layer. Electrical power is then applied to the two conductive portions such that, electrical current passes through the nanowires of the first layer, which functions to generate heat as the current passes through the nanowires. In addition, the heating element may be applied to existing surfaces of a space in, for example, the form of a paint that is painted onto a wall surface. The space may include a multiple sensor pack, which could be in wireless communication with multiple devices, or adaptors. An adaptor may be configured to supply electrical power to the heating element and may also be in wireless communication with a controller. The controller may be adapted to further monitor the power usage of the various adaptors in addition to the control functions.

In one configuration, the system includes a nanowire heating element having a first layer having a base material and a nanowire material dispersed within the base material. The first layer is provided with first and second ends and the nanowire material comprises multiple nanowire elements, such that, at least some of the nanowire elements overlap with each other and are dispersed throughout the heating element. A conductive layer includes two conductive elements that are spaced apart at a distance relative to each other. The first conductive element is positioned at a first end of the heating element and the second conductive element is positioned at a second end the heating element. A source of electrical power is connected to the first and second conductive elements. Electrical current passes between the first and second conductive elements by means of the various nanowire elements dispersed in the heating element. The passage of electrical current through the nanowires generates heat across the heating element. Finally, a top-coat layer may be applied over the conductive layer and the first layer where the top-coat layer may comprise a layer of paint. In one aspect, this top-coat may be thermally conductive paint.

The paint or film may comprise various base configurations including, for example, but not limited to: water-based, acrylic or latex based paint. Additionally, organic solvent based paints may effectively be used including, for example, an oil base paint. In still other configurations, resin based paints may be utilized. Likewise, the paint may be opaque, translucent or transparent, depending on the application. The base material may also be a water-based, acrylic or latex based paint.

The nanowire material in the heating element is conceived as conductive nanowires, which preferably can be silver nanowires. It is understood that other conductive materials such as, gold, platinum, copper, carbon and other conductive materials may also be used. Still further, the conductive nanowires may comprise an alloy. In one preferred configuration, silver nanowires comprising a relatively “high” purity of silver (e.g., above 80% or more preferably above 90% purity) are used.

In another configuration of the system, a nanowire paint is provided with conductive nanowire material dispersed therein having a length at least 500 times greater than their thickness and accounting for less than 10% by weight of the nanowire paint and the thickness of the nanowires is less than 300 nm. The nanowire paint may have a dry mil thickness of at least 0.5 mils. The nanowire paint may include a surfactant in an amount less than 500 ppm or about 50 ppm. A length of the nanowires may be in the range of about 10 to about 50 microns.

Nanowires have been known for use in touchscreen applications, however, the concentration of and size of the nanowires used in these applications differs significantly from that described above. For example, in typical touch screen applications have a substrate with light transmission typically approximately 95% and haze <1% with a sheet resistance range of approximately 50-100 ohms/sq. These types of films are produced with a low density of nanowires, where the nanowires have a diameter of approximately 20 nm with relatively larges spaces between the nanowires. The combination of the thin nanowires and the low-density result in high light transmission properties and low haze. Light transmission can be >98% with haze being <1% and more recently even <0.15%.

In contrast, the nanowires used in the current system are much larger than those used in touchscreen applications. For example, the nanowire diameter used in the paint or film for the heating system is ≥50 nm and more particularly, is ≥70 nm. The combination of higher density loading, thicker film thickness, thicker NWs and smaller spaces results in very different light transmission properties that would be unacceptable for touchscreen applications. Another difference from the layers applied to a touchscreen is that the paint used for heating is applied as a single layer to the surface (e.g., to the wall) without any flexible layer overlaying the nano paint. While another decorative paint may be applied over top of the nanowire paint, that paint layer is not functional nor is it “flexible” or deformable in the manner that a flexible overlying layer is provided on a touchscreen in order to allow it to function as a touchscreen.

In still another configuration the system allows for management of energy usage by means of a plurality of adaptors that measure energy usage at the adaptor and includes a controller for controlling energy usage. A sensor pack may be providing having a housing including a plurality of sensors and in wireless communication with one or more of the adaptors. In certain configurations, the sensor pack is separate from the adaptors such that, the sensor pack may be remotely positioned relative to the adaptors. A computer may be coupled to the sensor packs for receiving energy usage data. The computer may be provided with a program adapted to control energy usage at the adaptors.

The control data may also include a ruleset for reducing energy usage at the adaptors based on a threshold energy usage. This threshold may further be associated with a peak demand threshold that indicates a change in cost per unit of energy used if the peak demand threshold is surpassed during peak demand periods. The program may control the total and granular energy usage in a different manner during times with the threshold is exceeded during peak demand as opposed to off peak demand.

In further configurations, the system may be provided such that control inputs are generated in response to an electronic request received from a remote computer associated with an energy ISO or grid operator. The electronic request may be indicative of a request to reduce energy usage. A profile program, which may comprise a programmed series of events and/or actions, may be accessible to the computer such that, if an electronic request is received, the computer may implement the profile program.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

In one embodiment, an energy control system adapted to controlling systems in a space, the system comprising a first layer including a first end and a second end, a first material and conductive nanowire elements dispersed throughout the first material such that the nanowire elements have a spacing from each other in a range of from 200 nm to 1,000 nm. The system further comprises a second layer including a first conductive element positioned on the first end of the first material and a second conductive element positioned on the second end of the first material. The system still further comprises a first electrical conductor coupled to the first conductive element, a second electrical conductor coupled to the second conductive element and a source of electrical power coupled to the first and second conductors and adapted to provide electrical power to the first and second conductive elements. Finally, the system comprises a third layer positioned over the second and the first layers. The system is provided such that when electrical power is applied to the first and second conductors, electrical current flows through at least some of the conductive nanowire elements between the first and second conductive elements generating heat.

In another embodiment an energy demand management system is provided comprising a plurality of adapters which measure energy usage at the adaptor and include controllers for controlling energy usage and a plurality of sensors for providing an input to the plurality of adapters, each of the plurality of sensors providing data relating to an area the sensor is associated with. The system further comprises a computer in communication with the plurality of adapters via a network and software executing on the computer which generates control inputs for transmission to at least one of the plurality of adapters, the control inputs being generated based on measured energy usage of the plurality of adapters in comparison to a threshold of energy usage related to the plurality of adapters, the threshold of energy usage indicative of a peak demand value of energy usage where a per usage charge for energy usage is greater when the threshold is exceeded.

In still another configuration, a nanowire paint is provided comprising a paint base having conductive nanowire elements dispersed therein such that the nanowires have a length at least 500 times greater than their thickness and account for less than about 10% by weight of the nanowire paint and a surfactant in the amount less than 500 ppm. The nanowire paint is provided such that the nanowire paint has a dry mil thickness of at least about 0.5 mils.

In yet another configuration, a nanowire paint is provided comprising a paint base having conductive sliver nanowire elements dispersed therein such that the nanowires have a diameter of at least 50 nm and a length at least 500 times greater than their thickness, and a surfactant in the amount from about 50 ppm to about 500 ppm. The nanowire paint is provided such that the sliver nanowire paint has a dry mil thickness of at least about 0.5 mils.

In another configuration, a nanowire paint is provided comprising a paint base having conductive sliver nanowire elements dispersed therein such that the nanowires have a length at least 500 times greater than their thickness, and a surfactant in the amount from about 50 ppm to about 500 ppm. The nanowire paint is provided such that the sliver nanowire paint has a dry mil thickness of at least about 0.5 mils and the resistivity of the paint when dry is in a range of from 0.1 ohm/sq to about 2 ohm/sq.

In still another configuration, a nanowire paint is provided comprising a paint base having conductive sliver nanowire elements dispersed therein such that the nanowires have a diameter of at least 50 nm and a length at least 500 times greater than their thickness, and a surfactant in the amount from about 50 ppm to about 500 ppm. The nanowire paint is provided such that the sliver nanowire paint has a dry mil thickness of at least about 0.5 mils and the resistivity of the paint when dry is in a range of from 0.1 ohm/sq to about 2 ohm/sq., and the paint exhibits a light transmittance less than 85% and a haze of at least 10%.

Other objects of the invention and its particular features and advantages will become more apparent from consideration of the following drawings and accompanying detailed description.

### BRIEF DESCRIPTION OF THE DRAWINGS

FIG. 1 is a block diagram of one configuration of the system for energy management.

FIG. 2 is block diagram illustrating one configuration for a sensor pack according to the system of FIG. 1.

FIG. 3 is a block diagram according to FIG. 2.

FIG. 4 is a perspective view of a configuration for the nanowire heating element according to the system of FIG. 1.

FIG. 5 is a front view of a nanowire heating element according to FIG. 4.

FIG. 6 is an illustration of a side view of the heating element mounted on an inner surface of an exterior wall.

FIG. 7 is an illustration of a top view of the heating element mounted on opposing surfaces of an interior wall.

FIG. 8 is an illustration of a side view of the heating element mounted on an inner surface of a ceiling.

FIG. 9 is a block diagram of a control system for controlling the nanowire heating element illustrated in FIG. 4.

FIG. 10 shows a block diagram of a control system for the nanowire heating element illustrated in FIG. 4 connected to a wall electrical outlet.

FIG. 11 shows another configuration for the control system according to FIG. 11.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

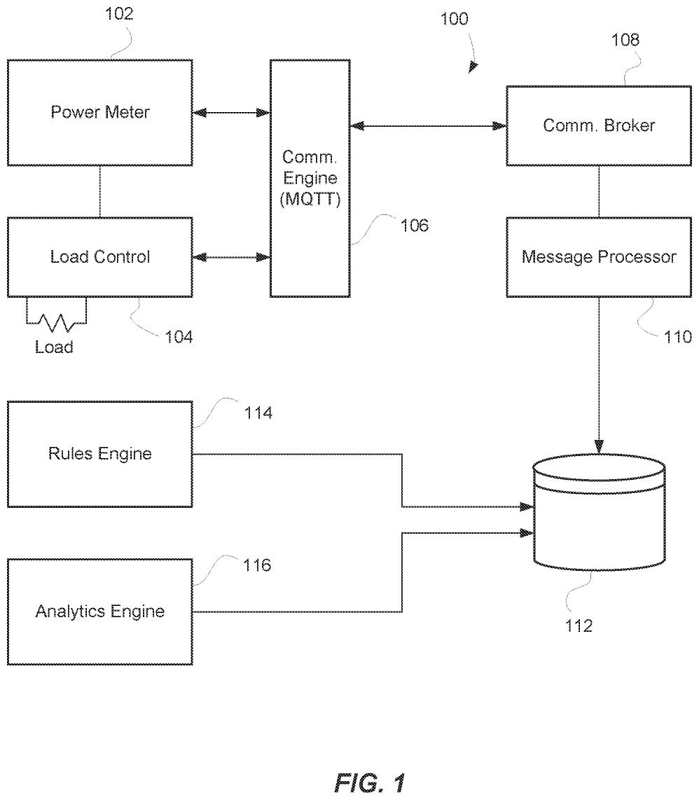

FIG. 1 is a block diagram illustrating details of an adaptor 100, which may include a power meter 102 and a load controller 104 in communication with a communications engine 106 such as, MQ Telemetry Transport (MQTT). A communications broker 108 and a message processor 110 enable communication of data between the adaptor 100 and the data repository 112. This communication may include usage data being transmitted to the data repository 112. Alternately, a control input may be generated by the rules engine 114 or analytics engine 116.

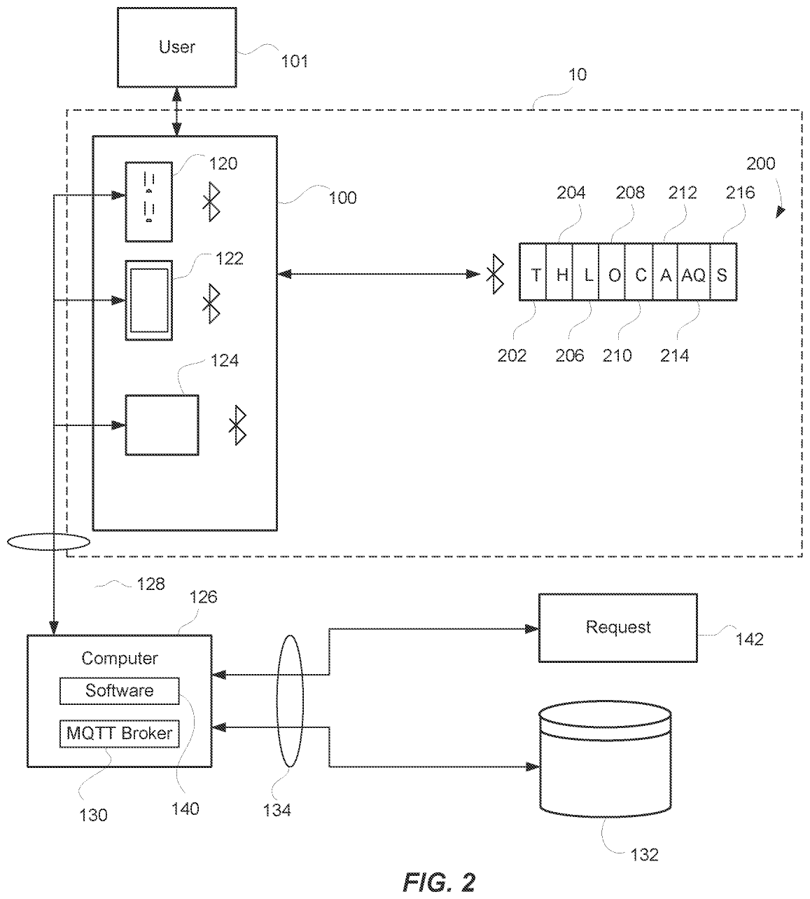

Referring to FIG. 2, adaptors 100 such as, outlets 120, switches 122 and other devices 124 are positioned throughout a space or area 10. The adaptors 100 include one or more of wireless communication hardware, energy consumption measurement hardware and control hardware.

Sensor pack 200 may include a housing with multiple sensors 202-216. The sensor pack 200 may be mounted to a wall or other location within room 10. Sensors include a temperature sensor 202, humidity sensor 204, light level sensor 206, occupancy sensor 208, audio sensor 210, infrared sensor 212, air quality sensor 214 and smoke sensor 216. These are just some examples of sensors that can be used and it is understood that other sensors may be included in sensor pack 200. It is further understood that although a single sensor pack 200 is shown in the room 10, multiple sensor packs can be installed as needed to properly read the conditions within a particular space or area. The adaptors 100 communicate with sensor pack 200 via, in one example, Bluetooth Low Energy (BLE) or other suitable wireless communication. In this way, the sensor pack 200 includes a separate power source from the adaptors 100. The power source may be a battery and because of the very low power consumption of the BLE communication protocol, the battery can last multiple years.

The temperature sensor 204 provides for granular temperature monitoring for a particular sensor location. Typically the sensor is capable of measuring temperatures between −30 F and 180 F, but other ranges are contemplated. The humidity sensor 204 detects relative humidity in the area of the sensor. Exemplary range of readings is 0-95%. The data from this sensor can be used to affect change in HVAC settings or air quality systems and trigger alerts for over or under humid conditions. The light level sensor 206 measures ambient light in the area of the sensor as exterior rooms can include differing light levels from exterior windows toward the interior of the building. This data can be used to dynamically adjust lighting levels and take advantage of natural light. Alerts can be triggered for under/over lit conditions. The occupancy sensor 208 is provided to detect movement in the vicinity of the sensor. A determination that a space or area is occupied, could be used to trigger a profile or to activate various functions of the networked sensor. The occupancy sensor could also include a Bluetooth connection, RFID, infrared or other sensor that determines when a particular device associated with a particular user profile is in the room. For example, a particular user's phone being present could indicate an individual is present. Alternately, an adaptor 100 within the room may pair with the user's phone in addition to the sensor pack 200. In addition, many buildings have keycard access and the keycards are individualized such that when detected in a particular room, this is generally where the person associated with such keycard is. The camera 210 can be used for added video surveillance and building security. In addition, the camera 210 can be used to determine occupancy of the building for determining environmental adjustments. For example, a room with ten people would heat up faster than the same room with just one person, thus HVAC controls can be adjusted to input less heat or increase cooling (depending on the particular conditions required). The Audio sensor 212 promotes enhanced workplace safety and security. The sensor capability also enables voice command activation to control environmental conditions of the room. The air quality sensor 214 can detect CO2 or other parameters to ensure that workspace air quality is within an acceptable range. If the air quality parameters are outside acceptable ranges, the one of the adaptors 100 may include a controlled vent 124 which can open to introduce fresh air into the room. Smoke sensor 216 can trigger alerts when smoke levels are above an acceptable range. This can also be tied to a security monitoring system via one of the adaptors 100 such that a message can trigger a fire alarm. In this scenario, active electrical devices may be shut off to reduce the spread of fire.

The adaptors 100 further include wireless communication hardware that communicate with a computer 126 over a network connection 128. The computer 126 may include a MQTT broker 130. MQTT is an ISO standard publish-subscribe based lightweight messaging protocol for use on top of the TCP/IP protocol. MQTT is especially useful because it uses a minimal amount of bandwidth to communicate. It is understood that other communication protocols may be used.

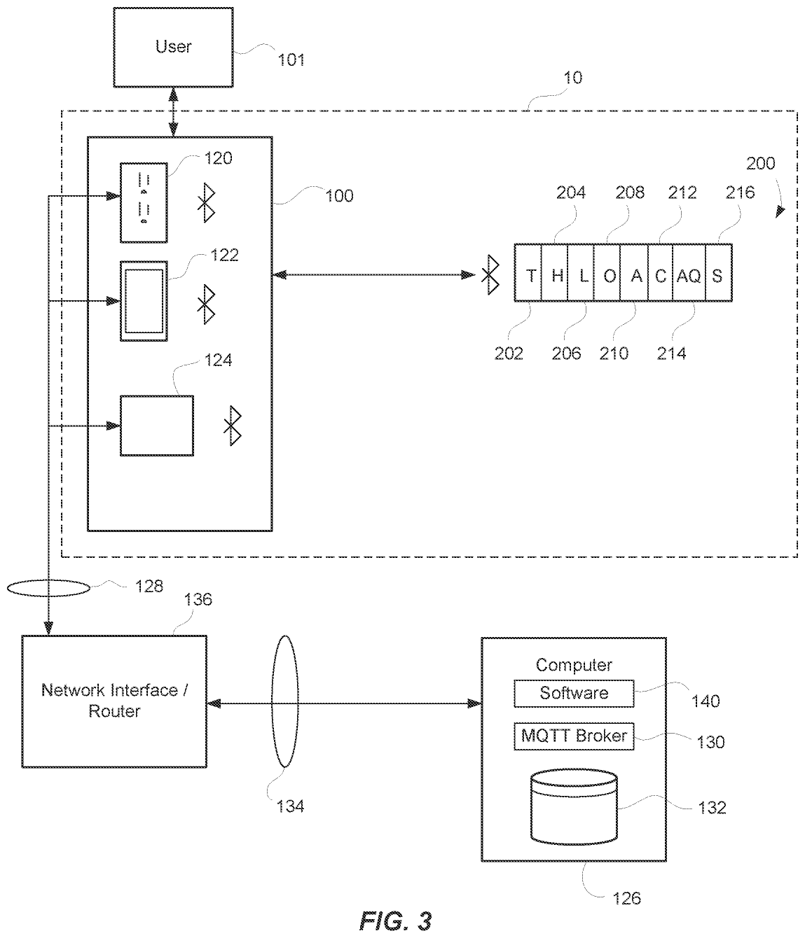

In the embodiment shown in FIG. 2, the adaptors 100 are connected to a computer 126 and communicate via network connection 128 with the MQTT broker 130 and are further able to communicate with offsite database 132 via public internet 134. FIG. 3 shows communication of an offsite computer via a router 136.

The controller is programmed to modify usage via the adaptors 100 based on overall usage and based on sensor readings from the sensor pack 200.

The sensor pack 200 is paired with one or more adaptors 100. The sensor pack 200 may be comprised of multiple modules, where each sensor is one module. The modules may be selectively selected and inserted into the housing to configure the sensor pack 200 for the particular room. The housing would contain the power and BLE communications hardware. Additional blank modules can be provided to slide into the housing to fill empty space. The readings from the sensors 202-216 are used to control multiple adaptors 100. For example, a single sensor pack 200 can provide readings to enable control of multiple outlets, switches, lights, thermostats, vents and other energy using devices.

Currently a facility/building entity is managed on an area by area basis using a loosely coupled collection of sensors. The sensor pack provides a fine grained approach to environmental sensing within individual spaces/rooms within a building. The sensors 202-216 may communicate on an event driven basis. For example, when occupancy changes, a message is sent so that the information is not streamed continuously. The same holds true for temperature or other conditions. This reduces power consumption by the sensor pack 200 and thereby increases battery life. When the message is sent to the computer 126, it is then communicated to the offsite database 132 via public internet 134. In this way, the facility usage and status can be monitored on a room by room basis from the database 132. The computer 126 can also be programmed to implement various profiles. The profiles can be based on particular users 101 or overall system profiles. In addition, the profiles can take into account the usage of the facility as a whole as compared to rate based targets or thresholds.

For example, if the rate per kilowatt charged increases if usage passes a certain threshold at a given time, there may be a higher rate for electricity usage that applies thereafter (known a peak demand). The facility profile can be configured such that when usage begins to approach this threshold, power consumption is reduced where possible. For example, lights may be dimmed to reduce power consumption. In addition, normal occupancy rules may require shutoff when no movement is detected in 5 minutes. In a scenario where power usage needs to be reduced, rooms with activity closest to 5 minutes may be shut off first until power usage reaches the desired level.

In one configuration a request 142 may be received from a remote computer associated with an energy ISO or grid operator. The request may 142 could be indicative of a request to reduce energy usage.

The system can also receive input(s) to establish profiles for the particular user 101. As shown in FIG. 2, the user 101 can connect directly to the adaptor(s) 100 and the connection to one adaptor can enable the user to control other adaptors within the area or space. It is understood that the user 101 may connect with a computer such as a laptop, tablet or mobile phone. In addition, the user 101 may be able to connect to the computer 126 via Wi-Fi or local internet 128 or alternately via public internet 134. It is understood that the system can be configured in many different ways to enable user 101 to establish control profiles and other settings for the room 10 or the facility in general, depending on the user's login permissions.

When a profile is established, the user 101 may input their ideal room temperature, their desired lighting profile, their curtailment tolerance level during demand curtailment and various other parameters. The system may further be configured to suggest standard profiles. The user may also establish a link to their mobile phone, which can provide location information so that it can be determined who is present at the facility/room on any given day. The temperature of shared spaces could be adjusted to reflect who is actually present or expected at the facility at any given moment. So, if as a group, the preferred temperature is 72 degrees, shared spaces may be controlled to 72 degrees. In order to enable the HVAC system to be configured to accomplish room by room temperature adjustments, vent openings can include a motorized control that retrofits to existing manual vent adjustment mechanisms. In alternate configurations, replacement vents may be used. These vent dampers can be considered one of the many options that could be encompassed by adaptor 124.

Software 140 is provided to provide for control of the various features described above. Software 140 enables control of energy consuming devices in a more efficient way. Most Internet of Things (IoT) devices such as outlets and switches are simply configured to enable wireless control without measurement of usage. However, placing the control and measurement of energy in the same IoT device provides significant benefits.

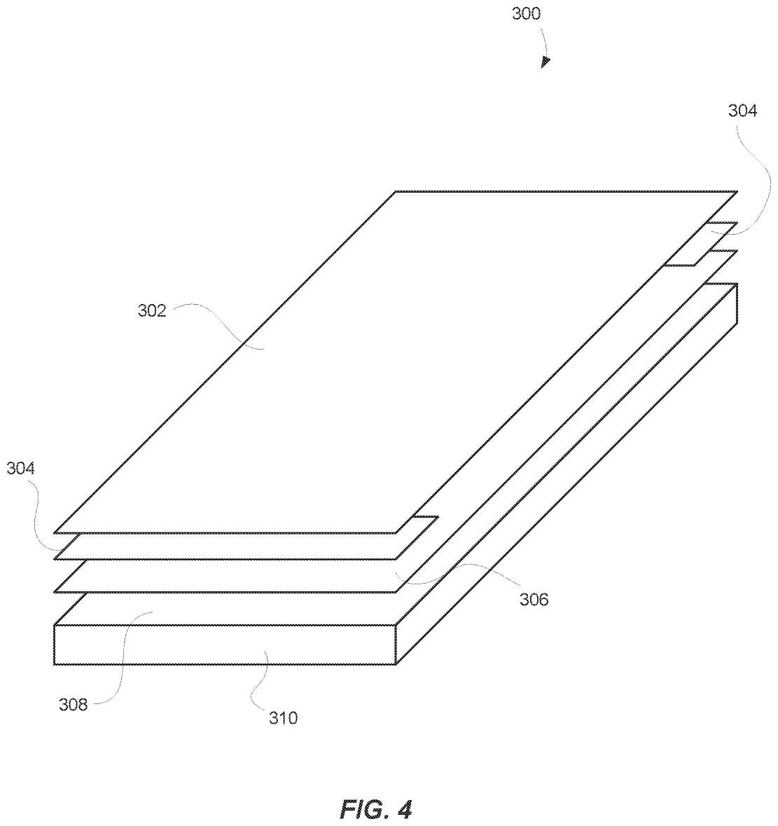

Turning now to FIG. 4 an example of the nanowire temperature control system 300 is provided.

The management system 100 and sensor pack 200 described above may be configured to include nanowire heating elements to enable granular control of heating in various spaces or areas, which may be within a building. Although silver nanowire is described as one preferred configuration, other conductive nanowires, such as metallic or alloy nanowires or copper nanowires or other conductive nanowire or nanotube elements such as carbon nanotubes, can effectively be used.

Nanowire heating elements utilize a radiant method of heating space, which is known to be highly efficient. Since nanowire heating elements use electricity, they can be powered easily by a renewable source such as, solar power. Nanowire heating elements provide a favorable efficiency level by using a combination of the high technology material and electricity.

In one configuration, the design uses a locally sourced heat method in each room, meaning each individual space within a commercial or residential facility has its own originating source of energy, and will have its own exclusive temperature control and measurement of heat levels and energy use. This allows for more individual control of spaces, leading to greater flexibility, variability, and efficiency across a building. This method is called Intelligent Room Management, and enables a more granular matching of presence in any individual space with the temperature required in that individual space. Current control methodologies operate at a higher level, which functions to waste energy due to the unoccupied condition of the space within a larger home or commercial building. It is estimated that approximately 30% of all commercial office space is unoccupied at a given time.

The heating element preferably uses silver nanowire, and can be mixed in a variety of densities by mixing with coatings like paint or transparent liquids that can coat surfaces and things including, but not limited to windows, floor molding, crown molding, walls, ceilings, floors, tables, counters, mirrors and many other surfaces and things. It can also be used to coat any separately designed radiant heat material that can be fixed or placed in any space.

Nanowire material comprises microscopic strands of pure silver laying on top of one another like a mesh, but is so small, it is invisible to the naked eye and can be produced in liquid layers like paint or any transparent liquids and applied in either a controlled environment, or in an uncontrolled environment like painting a wall in a building. FIG. 4 shows one deployment of silver nanowire on a painted sheetrock surface. As can be seen, the top coating 302 may be any type of finish paint. Contact elements 304 are positioned between the top coating 302 and the nano material 306. A base coat 308 such as a primer, ensures proper adhesion to the sheetrock 310.

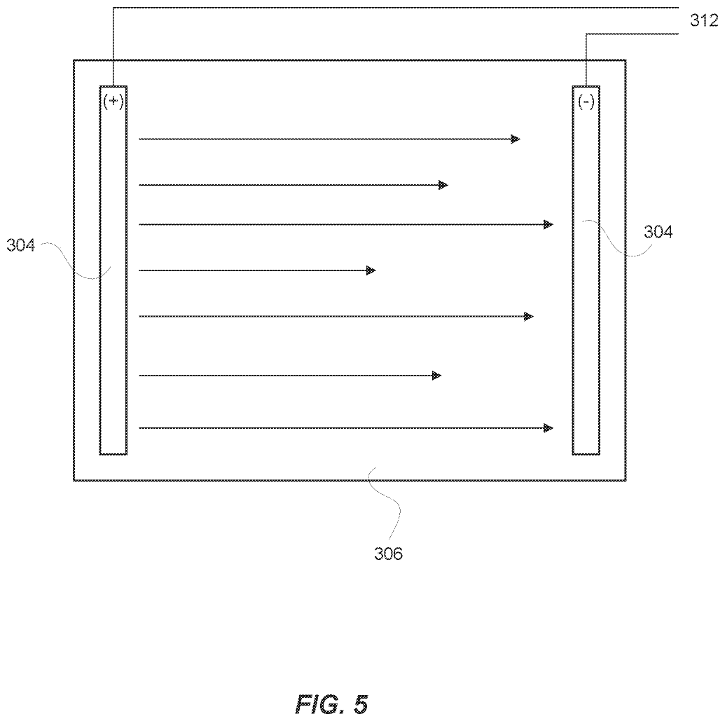

FIG. 5 shows how contact elements 304 are connected to an electrical power connection 312, and when electricity is applied to the contacts, current flows through the nanowire material (depicted with the arrows through the nano material 306) to produce heat.

This the nano material 306 is a conductive electric sheet, made of silver nanowire material. The silver nanowire material is highly conductive, so it can be heated to a reasonably warm level while enabling a “safe to touch” environment. Tests were able to achieve temperatures of 100 F degrees on a 2×2 foot piece of sheetrock with 70 watts of Direct Current (DC) power. Additional tests were performed using a one foot by one foot section of sheetrock and temperatures in excess of 147 degrees (F.) were achieved using 55 watts of DC power. The specific results of testing are included in Table 1.

TABLE 1
Heat Test 1

| Material | Nano Material | | | |
|---|---|---|---|---|
| Description | Nano Heated material, closed 1 × 1 box, uncoated walls | | | |
| Electrical Power | 55 Watts | | | |
| | T4 - | T3- | | |
| | Emitter- | Opposite | T1- | T2- |
| | uncoated | Inside- | Opposite | Inside Air- |
| Time | walls | uncoated | Outside | uncoated |
| 0 | 77.4 | 77 | 75.4 | 72.1 |
| 1 | 100.9 | 76.8 | 75 | 73.4 |
| 2 | 110.8 | 77 | 74.8 | 74.1 |
| 4 | 123.1 | 77.5 | 74.8 | 75.2 |
| 6 | 130.6 | 77.9 | 74.8 | 76.3 |
| 8 | 136.4 | 78.4 | 75 | 77 |
| 10 | 140.4 | 79.2 | 75.4 | 77.7 |
| 15 | 147.2 | 80.4 | 76.3 | 79.5 |

Additionally, the nanowire paint is applied in a relatively thin layer on walls or windows, leading to a fairly low cost and greatly simplified installation for both new and existing facilities. Coverage is an important factor to consider in any heating design. This system configuration allows for wide and fully customized coverage to maximize the time to heat, the level of heat required, and the room size and objects requiring heating.

It should be noted that the current systems contemplate many different configurations for the nanowire heating elements including but not limited to wall paint, film applied to walls or ceilings, windows, conduit plates, coated ceiling tiles, coated floors, sheetrock, separate heat materials applied to interior spaces like coated moldings, coated heaters in any shape and size, and the like.

A further aspect of the system relates to the insulation factor of the system. The silver nanowire has one of the highest insulation factors depending on its density. This means that the nano material 306 functions as an insulation layer with little to no thickness. In particular, the insulation quality is primarily as a radiant barrier, such that the material acts as a barrier to the infrared radiant energy waves by blocking many of the waves. This is due, at least in part, because the microscopic spaces between the nanowires are created to be smaller than the size of many of the waves in the heat spectrum. The silver then reflects many of these infrared waves back to the space from where they originated acting in a similar manner to radiant products like aluminum foil which are typically used on roofs of homes to keep the heat of the sun out during warmer months to significantly reduce the structure's air conditioning load. This material, however, is easier to install and can therefore be implemented inside walls of rooms within a structure, or in ceilings to provide a radiant barrier to reduce loss of temperature and deliver a more efficient outcome regardless of the heat or cooling source.

While pure silver is a relatively expensive material, the amount of silver needed given the microscopic size of the nanowire, makes this system economically sound. In tests the estimated cost of the silver nanowire was approximately 0.80 cents/square foot of coverage, however, it is expected that this can be reduced to as low as 0.15-25 cents per sq. ft. due to volume and dilution while still remaining effective to heat and insulate.

This new approach enables an almost endless coverage strategy to insulate and generate heat, including using a stripe around walls, covering baseboards only, including in other materials like ceiling tiles, carpets, hardwood flooring, or even replacing the need to install new more efficient windows. The nanowire solution can revolutionize window efficiency while enabling windows to actually become a heat source for the very first time.

The insulation application can be a completely separate approach to heating, and likely will be applied in a different method given that the amount of coverage necessary for heat creation in a space or area is so much less than the coverage required for radiant insulation. The concept of using a radiant barrier applied inside spaces to keep heat in, as opposed to keeping the heat out, is a new concept.

Currently several different formulations of silver nanowire materials are utilized for heating and insulation applications. Table 2 summarizes the formulations used for each application:

TABLE 2

| | | | | Aqeuous | | | |
|---|---|---|---|---|---|---|---|
| | | | | Dilution | | | |
| | | | | Fluid | Triton | | |
| | | | | Nanogap | X-100 | | |
| | | Poly- | | BATCH: | 0.5% | Batch | |
| Nano | | crylic | Water | DS0366- | Solution | Size | |
| Material | ml | ml | ml | DF ml | ml | ml | Notes |
| Nanogap | 15 | 15 | 20 | | | 50 | Formulation |
| 3170- | | | | | | | for heating |
| W2.64% | | | | | | | applications |
| Nanogap | 25 | | | 25 | | 50 | Combined |
| 3170- | | | | | | | heating and |
| INK | | | | | | | insulating |
| 2.56% | | | | | | | applications |
| BATCH: | | | | | | | |
| S0366 | | | | | | | |
| Nanogap | 15 | 10 | 24.5 | | 0.5 | 50 | Formulation |
| 3170- | | | | | | | for coating |
| W2.64% | | | | | | | glass |
| Nanogap | 50 | | | | | 50 | Insulation |
| 3170- | | | | | | | formulation |
| INK | | | | | | | |
| 2.56% | | | | | | | |
| BATCH: | | | | | | | |
| S0366 | | | | | | | |

The formulations are created by mixing the materials at room temperature. The formulation used for coating glass utilizes a relatively low concentration (50 parts polished/smooth surfaces. Higher or lower concentrations of surfactant are of course contemplated, depending on the application. Nanofiber/nanowire materials typically greater than 70 nm and more preferably, at least 100 nm in diameter and about 20-30 micron long silver fibers dispersed in polar solvents such as ethylene glycol, water, alcohols and glycol blends at wt/wt concentrations at about 5% or less, however, it is contemplated that concentrations of 10% or even 25-50% can be used or that nanowires may be mixed directly with paint. In one configuration, the diameter of the nanofiber/wire material is 500 nm with a length typically at least 250, preferably at least 750 or more preferably at least 1000 times the diameter. It is further contemplated that higher concentrations up to about 50% could effectively be used.

The length of the nanowires are typically long relative to the diameter to ensure numerous overlaps to allow for electrical connections between many wires and to allow electricity to pass between the two spaced apart sections of the conductive layer. Nano particle materials can also be used at 50-60 nm dispersed within ethylene glycol, water and alcohol/glycol blends at wt/wt concentrations up to 70%. The paint that creates the nanowire layer is typically, but is not necessarily, at least about 0.5 mils thick when dry.

Based on the above description, the combination of higher density loading, thicker film thickness, thicker NWs and smaller spaces results in very different light transmission properties that would be unacceptable for touchscreen applications as can be see in the following data. When testing the paint according to the current invention, four samples were tested with the following properties: Substrate—% Transmittance 93.4, % Haze 0.5; Sample 1—% Transmittance 83.0, % Haze 9.7; Sample 2—% Transmittance 73.0, % Haze 20.7; Sample 3—% Transmittance 77.6, % Haze 17.0; Sample 4—% Transmittance 80.4, % Haze 13.4.

The above values include the substrate, which if subtracted give transmission values of 80-90% and haze values of 9-20%, which is very different from the requirements of touchscreens that have transmission values of 99% and <1% haze. Associated with the higher silver density, and smaller spaces between nanowires, the measures sheet resistance is also much lower than in that used in touchscreens. For example, the resistances ranged from 1.2 ohm/sq, to 0.6 ohm/sq, to 0.4 ohm/sq in the various samples tested. Accordingly, the resistivity of the paint when dry will be in a range of from 0.1 ohm/sq to about 2 ohm/sq. This is very different from the typical touchscreen sheet resistances ranging from 50-100 ohms/sq.

For a radiant barrio, the silver nanowire elements may be applied to a painted surface or glass window in a liquid form and allowed to dry either naturally or with the aid of a low intensity heat gun. However, is should be noted that the % haze of 9-20% would limit the applications. For windows that were translucent, such as in a bathroom exterior window (or any other translucent glass), the % haze would not be problematic. It can also potentially be applied as a coating for textiles, ceiling and wall coverings, moldings, carpets or other floor material. The material that it coats has some degree of impact on its ability to emit and reflect heat, however, it is contemplated that the system is applicable to a wide variety of applications.

For heating applications, a conductive electrical contact strip is applied and connected on two sides of either a square or rectangle shape of the coating for the nanowire sheet 306 as depicted in FIGS. 4 and 5. The connections 304, which can comprise a highly conductive painted material, conduct electricity to the nanowire sheet 306. The nanowire sheet 306 will heat up and act as a radiant emitter on the wall, floor, ceiling, windows, or any area chosen to be the radiant heat source. The top coat 302 is provided as a protective layer to preserve the integrity of the nanowire sheet 306 and provide an additional safety barrier to prevent accidental electrical shorts. The amount of power produced into the coating can have a variable effect on the temperature used to heat the space. The electrical current can be attached anywhere on the coverage area through a copper (or similar conductor including but not limited to carbon or silver) cased conductor attachment which has a source of power including but not limited to coming from the electrical grid, a battery, or low voltage source or renewable energy source like solar.

The specific density of the nanowire will impact performance and output vs input in volts and the resulting current. The coverage area will heat up to a desired temperature, which in turn radiantly increases temperature in the space at a rate of speed dependent on the size of the coverage area, the amount of energy input to the coverage area, the size of the room including size and number of objects in the space, as well as the general insulation efficiency of the room.

The following tables summarize the testing results in addition to a 27% improvement in temperature rise time versus uncoated sheet rock. Table 3 illustrates the coated wall surface performance improvements. The summary table 4 shows consistent emitting surface and air temperature increase for the same power level, this shows the performance improvement associated with silver nanowire coatings.

TABLE 3
Heat Test 2

| Material | Nano Material | | | |
|---|---|---|---|---|
| Description | Nano Heated material, closed 1 × 1 box, coated walls | | | |
| Electrical Power | 55 Watts | | | |
| | T4- | T3- | | |
| | Emitter- | Opposite | T1- | T2- |
| | coated | Inside- | Opposite | Inside Air- |
| Time | walls | coated | Outside | coated |
| 0 | 87.2 | 72.7 | 71.8 | 78.3 |
| 1 | 105 | 73.2 | 71.8 | 76.6 |
| 2 | 116 | 73.6 | 72 | 77.2 |
| 2 | 116 | 73.6 | 72 | 77.2 |
| 4 | 127 | 74.7 | 72.1 | 77.9 |
| 6 | 135 | 75.7 | 72.7 | 78.8 |
| 8 | 140 | 76.6 | 73 | 79.5 |
| 10 | 143.6 | 77.9 | 73.6 | 80.6 |
| 15 | 149.5 | 79.9 | 74.3 | 82.2 |

TABLE 4
Summary-Difference Coated/Non Coated

| | T4-Emitting | | T3-Opposite | | T1-Outsdide | | | |
|---|---|---|---|---|---|---|---|---|
| | Surface | | Wall | | Air | | T2-Inside Air | |
| Time | Temp | % | Temp | % | Temp | % | Temp | % |
| 0 | 9.8 | 11.2% | −4.3 | −5.9% | −3.6 | −5.0% | 6.2 | 7.9% |
| 1 | 4.1 | 3.9% | −3.6 | −4.9% | −3.2 | −4.5% | 3.2 | 4.2% |
| 2 | 5.2 | 4.5% | −3.4 | −4.6% | −2.8 | −3.9% | 3.1 | 4.0% |
| 4 | 3.9 | 3.1% | −2.8 | −3.7% | −2.7 | −3.7% | 2.7 | 3.5% |
| 6 | 4.4 | 3.3% | −2.2 | −2.9% | −2.1 | −2.9% | 2.5 | 3.2% |
| 8 | 3.6 | 2.6% | −1.8 | −2.3% | −2 | −2.7% | 2.5 | 3.1% |
| 10 | 3.2 | 2.2% | −1.3 | −1.7% | −1.8 | −2.4% | 2.9 | 3.6% |
| 15 | 2.3 | 1.5% | −0.5 | −0.6% | −2 | −2.7% | 2.7 | 3.3% |

Emissivity is another variable in this new heating method. Emissivity is the efficiency of a materials ability to transfer heat through a radiant method using thermo magnetic transfer. It is expected that additional additives can be applied to the formulations that improve the emittance of the nanowire coating layer.

The insulation factor of the silver nanowire is derived from the following dynamic. The density of the nanowire can be produced with varying levels. The spaces between the nanowires are designed with a certain maximum gap size. When this gap is set to be smaller than the size of a thermal wavelength, the thermal wave cannot pass through the gap, which in turn, functions as a layer of radiant insulation. Silver nanowire structure can be applied with the density in the coating layer to be in a range that is smaller than the average size of a thermal wave. By diluting base nano material the coating can be optimized for either heating or insulation applications. Coating additives should be compatible with the nanowire material as oxidation will deteriorate the performance of the nano material.

More specifically, a thermal wave is typically around 2,000 nm, whereas the spaces between the crossing nanowires are designed to be in the range of 200 to 1,000 nm. It is estimated through testing that this barrier can create approximately 60%-90% insulation factor for local radiant waves assuming the design of the density of the nanowire supports that function. This insulation factor will be reduced as the density is reduced in the nanowire and gap in the structure is increased and approaches the size of the thermal wave mentioned above.

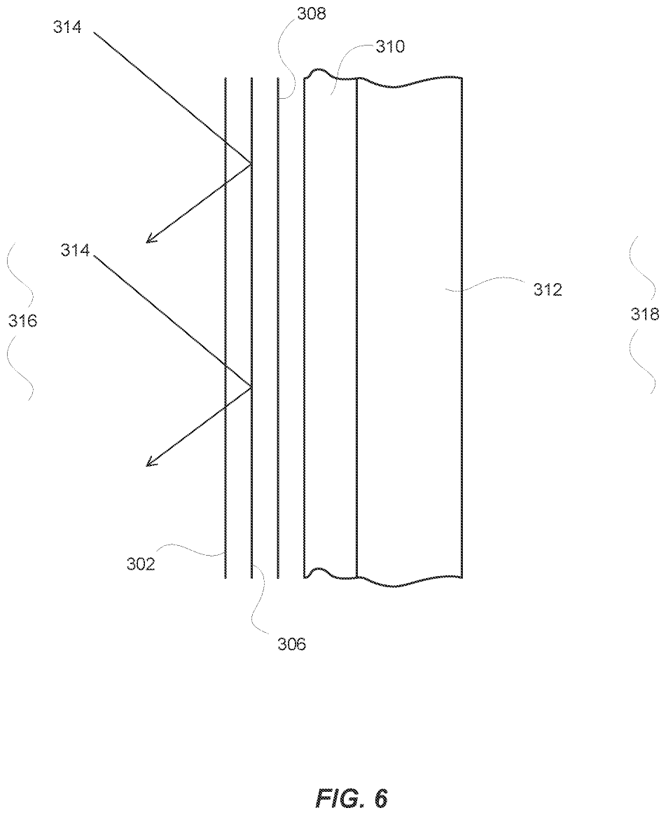

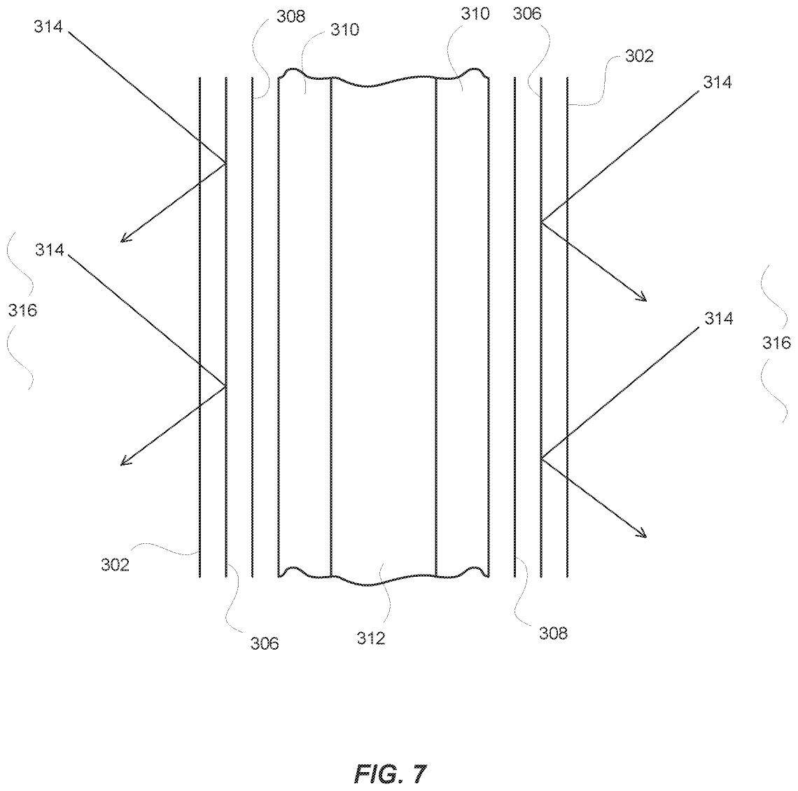

FIGS. 6 and 7 illustrate the behavior of the nanowire coating in for insulation applications in interior and exterior building applications. As the spaces between the nanowire material is provided being less than 200 nm, radiant heat is either retained in the occupied/interior space or prevented from entering the space so as to provide a radiant barrier to prevent excessive heat buildup and ultimately lower air conditioning expenses. For example, FIG. 6 illustrates the various layers including the protective top coat 302, the nanowire sheet 306, the base coat 308, sheetrock 310 and building stud 312 (the contacts 304 are not depicted). Radiant heat 314 is depicted with arrows that contact nanowire sheet 306 but do not penetrate and are reflected back into the interior space 316 while exterior space 318 is isolated. FIG. 7 is similar to FIG. 6 but shows an interior wall with two interior spaces 316.

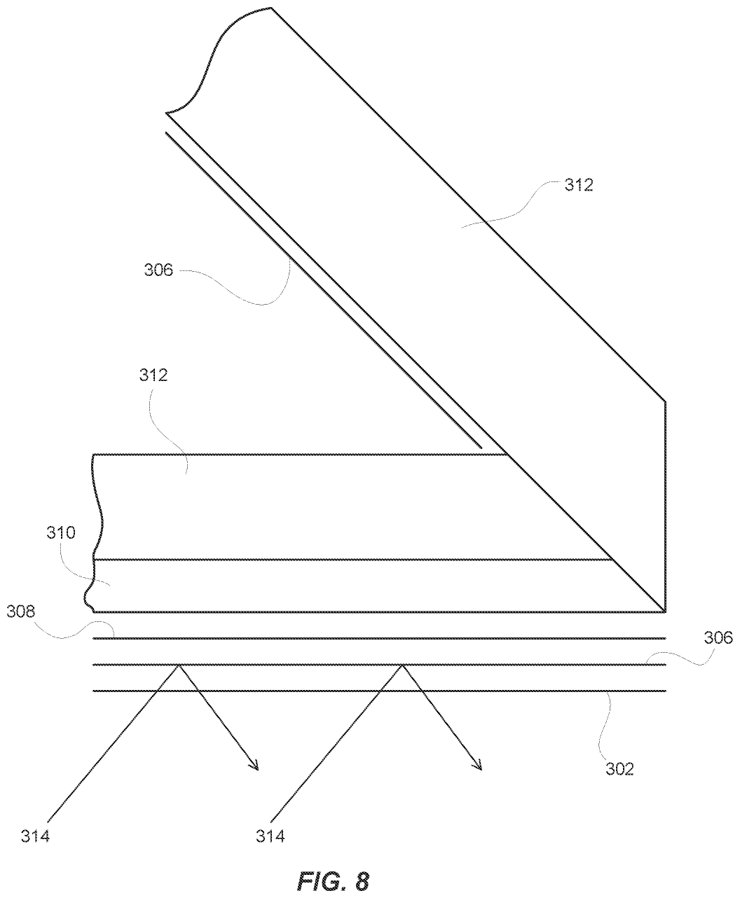

FIG. 8 illustrates silver Nanowire material applied as a radiant barrier in the roofing structure of a building to prevent excessive heat buildup. It is contemplated that this configuration could lower air conditioning costs by up to 30%.

It is further contemplated that local room sensors for temperature and air quality measurement can be provided that communicate with the electrical source supplying electricity to the nanowire element to maintain steady room temperature. Computer controlled management of this model is quite simple as the on/off model is much simpler than managing all of the variables like flow of water, water temp, air flow, temperature, energy loss, multiple insulation points of leakage and management, equipment efficiency, breakdowns, maintenance, risk of fire, carbon dioxide, price volatility of oil and natural gas, and carbon in the air. This system will be able to replace systems that have a very high construction cost associated with purchase and installation.

In another application, the nanowire element 306 may be connected to a network enabled outlet 120, which communicates with the sensor pack 200 described herein via Bluetooth. Sensors and circuitry may further be included to monitor and control the current through and temperature of the nanowire element 306 to ensure it does not overheat or short circuit. This circuitry may be located within the converter and optionally sensors may be applied to the nanowire element 306 as necessary. In one example, the sensor pack 200 could contain an infrared or thermal imaging camera that can determine the temperature of the nanowire element that is within the camera's field of view. It is understood that a transformer or other electrical converter such as a pulse width modulator can be used between the nanowire element 306 and the outlet 120 or other controller 124 to provide a voltage step down. In other configurations, a centralized low voltage source may be used.

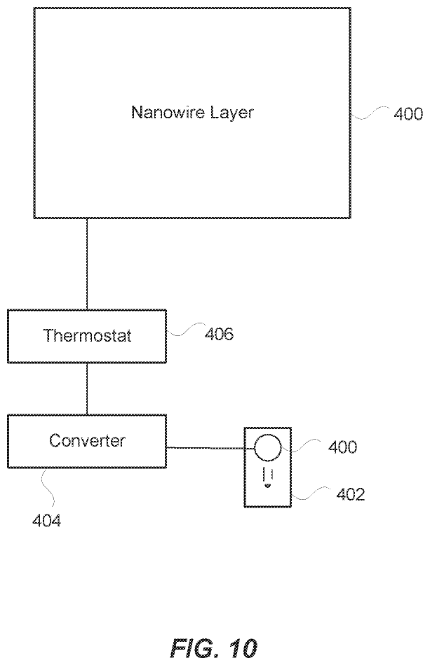

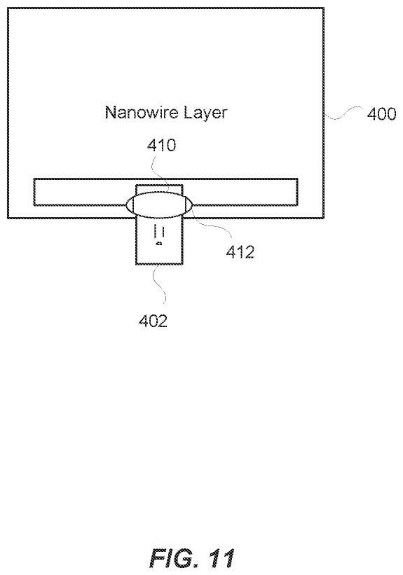

In addition to the use of networked systems for granular control of commercial buildings, the nanowire heating element also has applications for residential settings. In one example, the networked system of granular control can be used on individual rooms in a house. For example, a nanowire heating element can be placed in a room and connected to an energy source, which communicates with a thermostat to control the room temperature. One embodiment is shown in FIG. 10 a nanowire layer 400 is painted on a surface and connected to an outlet 402. The surface may be a wall or just about any other object that is in a space/location that requires heating. A converter 404 will normally reduce the voltage from the outlet 402 and/or switch from AC to DC current. A thermostat 406 controls how power is supplied to the nanowire layer based on the temperature setting for the room. The thermostat 406 may be a simple dial setting based thermostat or a more complicated computer controlled thermostat that allows for time, date and temperature settings. Although the thermostat 406 is shown electrically connected to the outlet, it is understood that the thermostat 406 may simply be a controller that is adjusted by a remote temperature sensor such as the sensor pack previously described or a simple temperature sensor and adjustor in Wi-Fi, radio or wired communication with the controller. In one embodiment, the thermostat 406 is Wi-Fi enabled. Although the plug 402, converter 404 and thermostat 406 are shown as separate elements, it is understood that these elements may be combined within the same housing 410 as shown in FIG. 11. FIG. 11 shows one example where the conductive layer 412 is integrated into the housing 410, which contains the plug that inserts to the outlet. In other embodiments, the electrical power is supplied from a central source and the heating element is controlled locally. In the embodiment of FIG. 11, the housing 410 extends beyond the outlet 402 to allow for an electrical connection between the conductive layer 412 on the housing and the nanowire layer 400. This housing 410 includes the converter 404, the thermostat 406 and plug 408 within one package.

FIG. 11 also shows an embodiment of the nanowire layer where thin strips of the layer extend from the outlet and then lead to a larger surface area conductive layer. This allows for an electrical connection to be made on either side of the nanowire layer without complicated wiring. Alternately, the thin strips shown may be thin copper or other conductive material that connects to the larger rectangular section of nanowire similar to what is shown in FIGS. 4 and 5. By placing the contacts to connect the nanowire layer 400 on either side of the outlet, the installation process is made easier in comparison to projects which may have the nanowire elements spaced apart at relatively large distances. However, if the nanowire elements have their ends for example, positioned at two different outlets spaced apart on a wall, this can enable connection to the power at two different outlets, which preferably are on the same circuit. It is understood that the nanowire coating can be applied to just about any surface or thing to create a modular heating/insulation element. This can include walls as described, but also includes furniture, windows, flooring, desks, baseboards, crown molding, mirrors, tables. This heating element can also be applied to other objects such as cars, boats, planes, storage sheds or just about any device, surface or thing that requires heating/insulation.

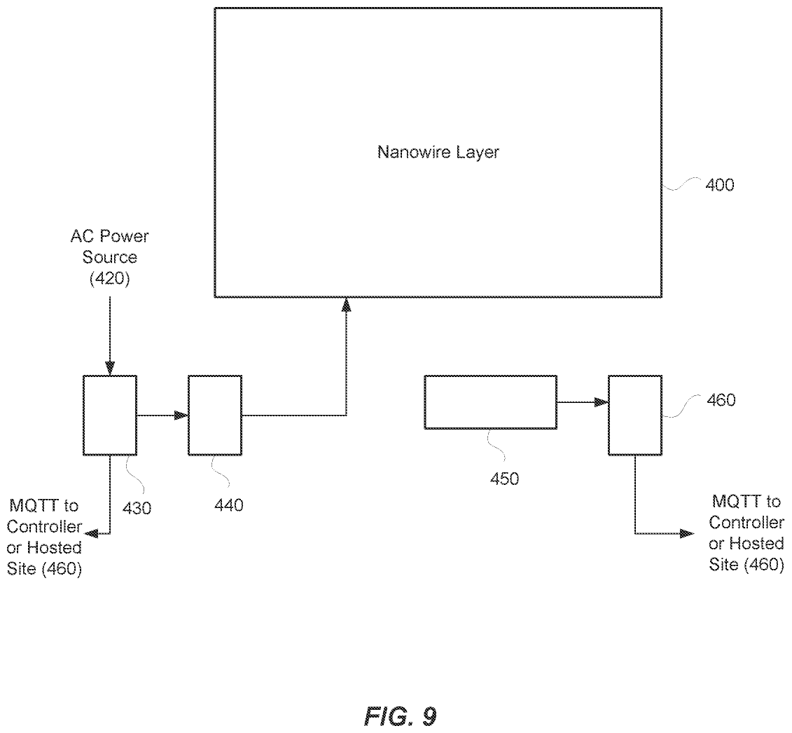

Since the invention removes the need for forced warm air, it is expected that in commercial applications an air quality system may still be necessary. While much less complex than a full AC system, it may still require air ducts to control humidity, CO2 levels, etc. Of course this would be much simpler and less expensive than current full blown air conditioning systems. FIG. 9 is a partial system diagram illustrating the plurality of components of the energy control ecosystem including, nanowire layer 400, AC power source 420, power pack 430, voltage step down 440, sense module 450, IoT device switch outlet, and then a connection 460 to MQTT to controller or hosted site.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A nanowire paint comprising:
a paint base having conductive sliver nanowire elements dispersed therein such that the nanowires have a diameter of at least 50 nm and a length at least 500 times greater than their thickness; and
a surfactant in the amount from about 50 ppm to about 500 ppm;
wherein the sliver nanowire paint has a dry mil thickness of at least about 0.5 mils.

2. The nanowire paint according to claim 1 wherein said nanowires have a diameter of at least 70 nm.

3. The nanowire paint according to claim 1 wherein said surfactant is in the amount of about 50 ppm.

4. The nanowire paint according to claim 1 wherein said paint base is selected from the group consisting of: an acrylic base, a latex base or a water base.

5. The nanowire paint according to claim 1 wherein the paint exhibits a light transmittance less than 85% and a haze of at least 10%.

6. The nanowire paint according to claim 1 wherein the paint is applied to a surface as a single paint layer with no overlaying flexible layer.

7. The nanowire paint according to claim 1 wherein the resistivity of the paint when dry is in a range of from 0.1 ohm/sq to about 2 ohm/sq.

8. A nanowire paint comprising:
a paint base having conductive sliver nanowire elements dispersed therein such that the nanowires have a length at least 500 times greater than their thickness; and
a surfactant in the amount from about 50 ppm to about 500 ppm;
wherein the sliver nanowire paint has a dry mil thickness of at least about 0.5 mils and the resistivity of the paint when dry is in a range of from 0.1 ohm/sq to about 2 ohm/sq.

9. The nanowire paint according to claim 1 wherein the length of the nanowires is at least 25 microns.

10. The nanowire paint according to claim 1 wherein said nanowires have a diameter of at least 50 nm.

11. The nanowire paint according to claim 1 wherein said nanowires have a diameter of at least 70 nm.

12. The nanowire paint according to claim 1 wherein said surfactant is in the amount of about 50 ppm.

13. The nanowire paint according to claim 1 wherein said paint base is selected from the group consisting of: an acrylic base, a latex base or a water base.

14. The nanowire paint according to claim 1 wherein the paint exhibits a light transmittance less than 85% and a haze of at least 10%.

15. The nanowire paint according to claim 1 wherein the paint is applied to a surface as a single paint layer with no overlaying flexible layer.

16. A nanowire paint comprising:
a paint base having conductive sliver nanowire elements dispersed therein such that the nanowires have a diameter of at least 50 nm and a length at least 500 times greater than their thickness; and
a surfactant in the amount from about 50 ppm to about 500 ppm;
wherein the sliver nanowire paint has a dry mil thickness of at least about 0.5 mils and the resistivity of the paint when dry is in a range of from 0.1 ohm/sq to about 2 ohm/sq.;
wherein the paint exhibits a light transmittance less than 85% and a haze of at least 10%.

17. The nanowire paint according to claim 1 wherein said nanowires have a diameter of at least 70 nm.

18. The nanowire paint according to claim 1 wherein said surfactant is in the amount of about 50 ppm.

19. The nanowire paint according to claim 1 wherein said paint base is selected from the group consisting of: an acrylic base, a latex base or a water base.

20. The nanowire paint according to claim 1 wherein the paint is applied to a surface as a single paint layer with no overlaying flexible layer.
